(19) United States
(12) Patent Application Publication
(10) Pub. No.: US 2026/0352242 A1
(43) Pub. Date: Nov. 5, 2026

(54) Transmitter with Local Oscillator Harmonic Suppression

(71) Applicant: Apple Inc., Cupertino, CA (US)

(72) Inventor: Omar E. Elaasar, San Diego, CA (US)

(21) Appl. No.: 19/194,633

(22) Filed: Apr. 30, 2025

(51) Int. Cl. H04B 1/04; H04B 17/391

(52) U.S. Cl. CPC H04B 1/0475; H04B 1/0483; H04B 17/3912; H04B 2001/0408

(57) ABSTRACT

A transmit path in wireless circuitry may include a mixer and a transformer. The mixer may be clocked using a local oscillator (LO). A secondary winding of the transformer may be coupled to a transmission line path. An adjustable capacitor may be coupled to a center tap of the secondary winding. A negative feedback path may couple the transmission line path to the adjustable capacitor. The negative feedback path may include a signal strength identifier (SSI) sensor, gain control circuitry, and offset circuitry. The negative feedback path may be used to identify optimal capacitances for the adjustable capacitor that suppress a second order harmonic of the LO signal produced by the mixer circuitry during transmission.

### FIELD

This disclosure relates generally to electronic devices, including electronic devices with communications circuitry.

### BACKGROUND

Electronic devices are often provided with communications capabilities. An electronic device with communications capabilities includes communications circuitry with a transmitter that transmits radio-frequency signals using a clock signal. If care is not taken, harmonics of the clock signal can deteriorate wireless performance of the transmitter in transmitting the radio-frequency signals.

### SUMMARY

An electronic device may be provided with wireless circuitry. The wireless circuitry may include a transmit path. The transmit path may include mixer circuitry and a transformer. The mixer circuitry may be clocked using a local oscillator (LO) signal. A primary winding of the transformer may be coupled to an output of the mixer circuitry. A secondary winding of the transformer may be coupled to a transmission line path. Tunable harmonic cancellation circuitry such as an adjustable capacitor may be coupled to a center tap of the secondary winding. A negative feedback path may couple the transmission line path to the adjustable capacitor.

The negative feedback path may include a signal strength identifier (SSI) sensor, gain control circuitry, and offset circuitry. The negative feedback path may be used to identify optimal capacitances for the adjustable capacitor that suppress a second order harmonic of the LO signal produced by the mixer circuitry during transmission. The negative feedback path may be closed while the mixer circuitry does not receive a transmit signal, allowing the SSI sensor to characterize second order harmonic emission from the LO signal on the transmission line path. The gain control circuitry may adjust the capacitance of the adjustable capacitor until the SSI sensor output converges to zero. The corresponding capacitance may represent the optimal capacitance for the corresponding frequency of the LO signal. The adjustable capacitor may be set to the optimal capacitances during subsequent signal transmission, effectively suppressing the effects of second order harmonic emission from the transmitted signal.

An aspect of the disclosure provides a transmitter. The transmitter can include mixer circuitry. The transmitter can include a transformer that includes a primary winding and a secondary winding, wherein the primary winding is coupled to an output of the mixer circuitry, and the secondary winding extends between a first terminal and a second terminal of the transformer. The transmitter can include a first signal line coupled to the first terminal. The transmitter can include a second signal line coupled to the second terminal. The transmitter can include an adjustable circuit coupled to a center tap of the secondary winding. The transmitter can include signal strength indicator (SSI) measurement circuitry having an input communicatively coupled to the first signal line and the second signal line and having an output communicatively coupled to the adjustable circuit.

An aspect of the disclosure provides wireless circuitry. The wireless circuitry can include mixer circuitry. The wireless circuitry can include a transformer that includes a primary winding and a secondary winding, the primary winding being coupled to an output of the mixer circuitry. The wireless circuitry can include a transmission line path coupled to the secondary winding. The wireless circuitry can include an adjustable capacitor that couples a center tap of the secondary winding to a reference potential. The wireless circuitry can include a sensor communicatively coupled to the transmission line path, wherein the sensor is configured to measure a signal strength indicator (SSI) value of a signal on the transmission line path, and the adjustable capacitor has a capacitance that is set based on the SSI value.

An aspect of the disclosure provides a method of operating a transmitter. The method can include generating, using a mixer during a first time period, a first signal based on a local oscillator signal. The method can include passing, using a transformer during the first time period, the first signal onto a transmission line, wherein the transformer includes a primary winding coupled to the mixer and includes a secondary winding coupled to the transmission line. The method can include measuring, using a sensor during the first time period, a signal strength indicator (SSI) value of the signal on the transmission line. The method can include identifying, using a feedback path coupled between the transmission line and an adjustable capacitor, a capacitance for the adjustable capacitor that minimizes the SSI value, wherein the adjustable capacitor is coupled to a center tap of the secondary winding. The method can include generating, using the mixer during a second time period, a second signal based on the local oscillator signal and a transmit signal. The method can include passing, using the transformer during the second time period, the second signal onto the transmission line while the adjustable capacitor exhibits the capacitance.

### BRIEF DESCRIPTION OF THE DRAWINGS

FIG. 1 is a diagram of an illustrative electronic device having wireless circuitry in accordance with some embodiments.

FIG. 2 is a diagram of illustrative wireless circuitry having a transceiver in accordance with some embodiments.

FIG. 3 is a circuit diagram of an illustrative transmit path of wireless circuitry in accordance with some embodiments.

FIG. 4 is a frequency diagram showing how a second harmonic of an illustrative local oscillator signal used to transmit a radio-frequency signal can deteriorate transmission performance of the radio-frequency signal in accordance with some embodiments.

FIG. 5 is a circuit diagram of an illustrative transmit path that includes a negative feedback loop with signal strength indicator (SSI) measurement circuitry, gain control circuitry, and tunable harmonic rejection circuitry in accordance with some embodiments.

FIG. 6 is a circuit diagram of an illustrative negative feedback loop that includes analog tunable harmonic rejection circuitry controlled by analog gain control circuitry in accordance with some embodiments.

FIG. 7 is a circuit diagram of an illustrative negative feedback loop that includes digital tunable harmonic rejection circuitry controlled by digital gain control circuitry in accordance with some embodiments.

FIG. 8 is a plot showing how a particular setting for tunable harmonic rejection circuitry may minimize second harmonic power in a transmitted radio-frequency signal in accordance with some embodiments.

FIG. 9 is a plot showing how illustrative tunable harmonic rejection circuitry may increase the dynamic range of signal strength indicator values measured from a transmitted radio-frequency signal in accordance with some embodiments.

FIG. 10 is a plot showing how illustrative tunable harmonic rejection circuitry may have a range of optimal settings for minimizing second harmonic power across a corresponding range of local oscillator frequencies in accordance with some embodiments.

FIG. 11 is a flow chart of illustrative operations involved in performing signal transmission using wireless circuitry of the types shown in FIGS. 5-7 in accordance with some embodiments.

### DETAILED DESCRIPTION

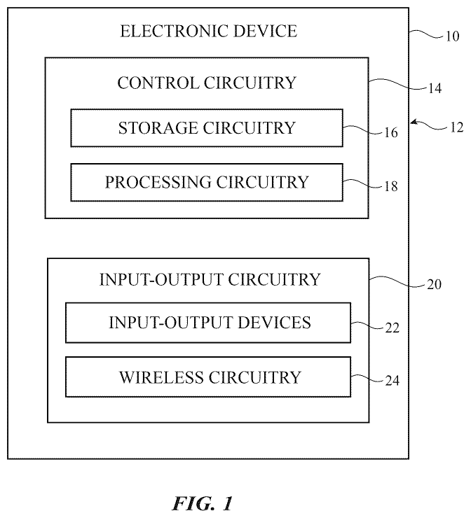

FIG. 1 is a block diagram of an electronic device 10 that may be provided with communications circuitry. Device 10 may be a computing device such as a laptop computer, a desktop computer, a computer monitor (e.g., containing an embedded computer), a tablet computer, a cellular telephone, a media player, or another handheld or portable electronic device, a smaller device such as a wristwatch device, a pendant device, a headphone or earpiece device, a device embedded in eyeglasses, goggles, a helmet, or other equipment worn on a user's head (e.g., an augmented, virtual, or mixed reality head-mounted display device), or another wearable or miniature device, a television, a computer display (e.g., that does not contain an embedded computer), a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in the functional block diagram of FIG. 1, device 10 may include components located on or within an electronic device housing such as housing 12. Housing 12, which may sometimes be referred to as a case, may be formed from plastic, glass, ceramics, fiber composites, metal (e.g., stainless steel, aluminum, metal alloys, etc.), other suitable materials, or a combination of these materials. In some embodiments, some or all of housing 12 may be formed from dielectric or other low-conductivity material (e.g., glass, ceramic, plastic, sapphire, etc.). In other embodiments, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors such as microprocessors, microcontrollers, digital signal processors, host processors, baseband processor integrated circuits, application specific integrated circuits, central processing units (CPUs), application processors, graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing wireless communications protocols (sometimes also referred to as communications protocols or communications standards). Communications protocols (standards) that may be implemented using control circuitry 14 include wireless local area network (WLAN) protocols (e.g., IEEE 802.11 protocols-sometimes referred to as Wi-Fi® such as a Wi-Fi 6 protocol, a Wi-Fi 7 protocol, or other Wi-Fi protocols), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), satellite navigation system protocols (e.g., global positioning system (GPS) protocols, global navigation satellite system (GLONASS) protocols, etc.), satellite communications (satcom) protocols, antenna-based spatial ranging protocols, optical communications protocols, or any other desired communications protocols. Each communications protocol may be associated with a corresponding radio access technology (RAT) that specifies the physical connection methodology used in implementing the protocol (e.g., used in transmitting and/or receiving radio-frequency signals under or according to the protocol).

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Input-output circuitry 20 may include communications circuitry that supports communications between components of device 10 and/or between device 10 and one or more external devices. The communications circuitry may include wired communications circuitry that conveys signals via one or more wired communications links over one or more wired paths (e.g., optical fiber paths, Ethernet paths, coaxial cable paths, conductive lines, serial paths, digital paths, analog paths, data paths, signal paths, interconnects, ports, etc.). Additionally, or alternatively, the communications circuitry may include wireless circuitry 24 that supports wireless communications (e.g., communications using wireless radio-frequency signals). Wireless circuitry 24 (sometimes referred to herein as wireless communications circuitry 24) may include one or more antennas. Wireless circuitry 24 may also include baseband processor circuitry, transceiver circuitry, amplifier circuitry, filter circuitry, switching circuitry, radio-frequency transmission lines, and/or any other circuitry for transmitting and/or receiving radio-frequency signals using the antenna(s).

Wireless communications performed by wireless circuitry 24 may include or involve wireless data communications (e.g., where wireless data is carried by radio-frequency signals conveyed between wireless circuitry 24 and other communications equipment bidirectionally or unidirectionally), radio-frequency signal transmission, radio-frequency signal reception, and/or radio-based spatial ranging/sensing (e.g., radio detection and ranging (radar) operations, shorter range object detection such as near-field radio-frequency signal-based object detection, etc.). Radio-frequency signals conveyed by wireless circuitry 24 may include or carry wireless data (e.g., organized into frames, packets, symbols, datagrams, etc.), radar or other spatial ranging waveforms, continuous wave signals, chirp signals, control signals, management signals, reference signals, beacon signals, tones, pulses/impulses, waveforms associated with one or more communications protocols, and/or any other radio-frequency waveforms or signals. Wireless circuitry 24 is sometimes also referred to herein as wireless communications circuitry 24, wireless communication circuitry 24, communications circuitry 24, or simply as circuitry 24. Wireless circuitry 24 may include one or more antennas. Wireless circuitry 24 may also include baseband processor circuitry, transceiver circuitry, amplifier circuitry, filter circuitry, switching circuitry, radio-frequency transmission lines, and/or any other circuitry for transmitting and/or receiving radio-frequency signals using the antenna(s). Some or all of the components of wireless circuitry 24 may be disposed on, mounted to, and/or integrated within the same substrate (e.g., a printed circuit board, semiconductor substrate, chip, integrated circuit (IC), IC packages, etc.) or may be distributed between two or more substrates (e.g., printed circuit boards, semiconductor substrates, chips, ICs, IC packages, etc.). Some or all of the signal generation, transmission, and/or reception operations described herein as being performed by wireless circuitry 24 may alternatively be performed by wired communications circuitry in input-output circuitry 20.

Wireless circuitry 24 may transmit and/or receive radio-frequency signals within a corresponding frequency band at radio frequencies (sometimes referred to herein as a communications band or simply as a “band”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), a Wi-Fi® 7 band, and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, etc.), other centimeter or millimeter wave frequency bands between 10-100 GHz, sub-THz frequency bands between around 100 GHz and 10 THz (e.g., 6G bands), near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, satellite communications (satcom) bands (e.g., an IEEE C band (4-8 GHz), S band (2-4 GHz), L band (1-2 GHz), X band (8-12 GHz), W band (75-110 GHz), V band (40-75 GHz), K band (18-27 GHz), Kₐ band (26.5-40 GHz), Kᵤ band (12-18 GHz), etc.), unlicensed bands, communications bands under the family of 3GPP wireless communications standards, communications bands under the IEEE 802.XX family of standards, and/or any other desired frequency bands of interest. Different communications protocols may utilize different frequency bands for conveying radio-frequency signals. In some cases, two or more communications protocols may utilize one or more of the same frequency bands for conveying radio-frequency signals.

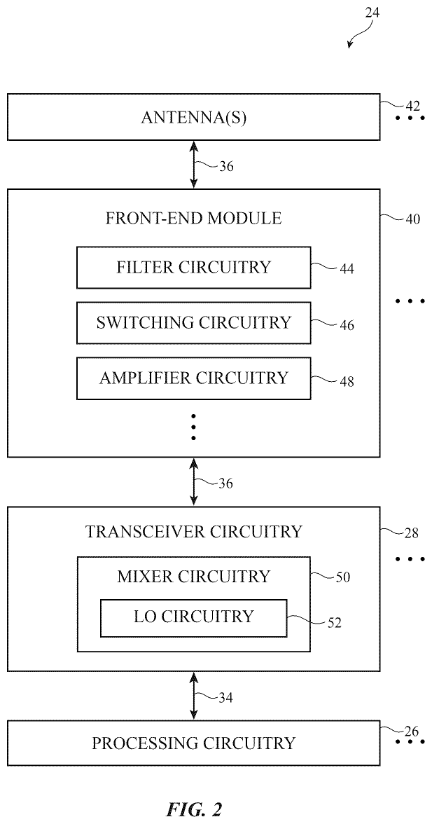

FIG. 2 is a diagram showing illustrative components within wireless circuitry 24. As shown in FIG. 2, wireless circuitry 24 may include processing circuitry 26, radio-frequency (RF) transceiver circuitry 28, radio-frequency front end circuitry such as radio-frequency front end (RFFE) module 40 (sometimes also referred to as front end module (FEM) 40), and antenna(s) 42. Processing circuitry 26 may include one or more baseband processors, application processors, general purpose processors, microprocessors, microcontrollers, digital signal processors, host processors, application specific signal processing hardware, and/or other types of processors. Processing circuitry 26 may be communicatively coupled to transceiver circuitry 28 over path 34. Transceiver circuitry 28 may be coupled to antenna 42 via radio-frequency transmission line path 36. Radio-frequency front end module 40 may be disposed on radio-frequency transmission line path 36 between transceiver circuitry 28 and antenna 42.

Transceiver circuitry 28 may include one or more transceivers. Each transceiver may include a transmitter and/or a receiver. In the example of FIG. 2, wireless circuitry 24 is illustrated as including only a single front end module 40 and a single antenna 42 for the sake of clarity. In general, wireless circuitry 24 may include any desired number of front end modules 40 and any desired number of antennas 42. If desired, processing circuitry 26 may be coupled to one or more transceivers in transceiver circuitry 28 over respective paths 34. Each transceiver may include a transmitter configured to output uplink signals to antenna 42 and/or a receiver configured to receive downlink signals from antenna 42. Each transceiver may be coupled to one or more antennas 42 over respective radio-frequency transmission line paths 36. Each radio-frequency transmission line path 36 may have a respective front end module 40 disposed thereon. If desired, two or more front end modules 40 may be disposed on the same radio-frequency transmission line path 36. If desired, one or more of the radio-frequency transmission line paths 36 in wireless circuitry 24 may be implemented without any front end module disposed thereon.

Radio-frequency transmission line path 36 may be coupled to an antenna feed on antenna 42. The antenna feed may, for example, include a positive antenna feed terminal and a ground antenna feed terminal. Radio-frequency transmission line path 36 may have a positive transmission line signal path that is coupled to the positive antenna feed terminal on antenna 42. Radio-frequency transmission line path 36 may have a ground transmission line signal path that is coupled to the ground antenna feed terminal on antenna 42. This example is illustrative and, in general, antennas 42 may be fed using any desired antenna feeding scheme. If desired, antenna 42 may have multiple antenna feeds that are coupled to one or more radio-frequency transmission line paths 36.

Radio-frequency transmission line path 36 may include transmission lines that are used to route radio-frequency antenna signals within device 10 (FIG. 1). Transmission lines in device 10 may include coaxial cables, microstrip transmission lines, stripline transmission lines, edge-coupled microstrip transmission lines, edge-coupled stripline transmission lines, transmission lines formed from combinations of transmission lines of these types, etc. Transmission lines in device 10 such as transmission lines in radio-frequency transmission line path 36 may be integrated into rigid and/or flexible printed circuit boards. Transmission lines in radio-frequency transmission line path 36 may include single-ended transmission lines that convey single-ended signals and/or may include differential transmission lines that convey differential signals.

While performing wireless transmission, processing circuitry 26 may provide transmit signals (e.g., digital or baseband signals) to transceiver circuitry 28 over path 34. Transceiver circuitry 28 may further include circuitry for converting the transmit (baseband) signals received from processing circuitry 26. For example, transceiver circuitry 28 may include mixer circuitry 50 that up-converts (or modulates) the transmit (baseband) signals to radio frequencies (and optionally intermediate frequencies) prior to transmission over antenna 42. The example of FIG. 2 in which processing circuitry 26 communicates with transceiver circuitry 28 is illustrative. In general, transceiver circuitry 28 may communicate with a baseband processor, an application processor, general purpose processor, a microcontroller, a microprocessor, or one or more processors within processing circuitry 18 (FIG. 1). Transceiver circuitry 28 may also include digital-to-analog converter (DAC) and/or analog-to-digital converter (ADC) circuitry for converting signals between digital and analog domains. Transceiver circuitry 28 may include a transmitter that transmits the radio-frequency signals over antenna 42 via radio-frequency transmission line path 36 and front end module 40. Antenna 42 may transmit the radio-frequency signals to external wireless equipment by radiating the radio-frequency signals into free space.

While performing wireless reception, antenna 42 may receive radio-frequency signals from the external wireless equipment. The received radio-frequency signals may be conveyed to transceiver circuitry 28 via radio-frequency transmission line path 36 and front end module 40. Transceiver circuitry 28 may include circuitry a receiver that receives signals from front end module 40 and that converts the received radio-frequency signals into corresponding baseband signals. For example, mixer circuitry 50 in transceiver circuitry 28 may down-convert (or demodulate) the received radio-frequency signals to baseband frequencies (and optionally intermediate frequencies) prior to conveying the received signals to processing circuitry 26 over path 34.

Mixer circuitry 50 may include clocking circuitry such as local oscillator (LO) circuitry 52. Local oscillator circuitry 52 (sometimes also referred to as clock generation circuitry 52 or LO signal generation circuitry 52) may include one or more reference oscillators, crystal oscillators, voltage controlled oscillators, phase-locked loops, frequency-locked loops, self-injection locked loops, and/or other clock generation circuitry that generates clock signals such as oscillator (oscillating) signals (e.g., local oscillator signals). Mixer circuitry 50 may use the oscillator signals generated by local oscillator circuitry 52 to modulate (upconvert) transmitted signals from baseband frequencies to radio frequencies, from baseband frequencies to intermediate frequencies, and/or from intermediate frequencies to radio frequencies. Additionally, or alternatively, mixer circuitry 50 may use the oscillator signals generated by local oscillator circuitry 52 to demodulate (downconvert) received signals from radio frequencies to baseband frequencies, from radio frequencies to intermediate frequencies, and/or from intermediate frequencies to baseband frequencies. Although local oscillator circuitry 52 is illustrated as being included within mixer circuitry 50 in FIG. 2 for the sake of simplicity, local oscillator circuitry 52 may, if desired, be implemented within transceiver circuitry 28 but external to mixer circuitry 50 or may be implemented external to transceiver circuitry 28.

Front end module (FEM) 40 may include radio-frequency front end circuitry that operates on the radio-frequency signals conveyed over radio-frequency transmission line path 36. FEM 40 may, for example, include front end module components such as radio-frequency filter circuitry 44 (e.g., low pass filters, high pass filters, notch filters, band pass filters, multiplexing circuitry, duplexer circuitry, diplexer circuitry, triplexer circuitry, etc.), switching circuitry 46 (e.g., one or more radio-frequency switches), radio-frequency amplifier circuitry 48 (e.g., one or more power amplifiers and/or one or more low-noise amplifiers), signal attenuators, impedance matching circuitry (e.g., circuitry that helps to match the impedance of antenna 42 to the impedance of radio-frequency transmission line 36), antenna tuning circuitry (e.g., networks of capacitors, resistors, inductors, and/or switches that adjust the frequency response of antenna 42), radio-frequency coupler circuitry, charge pump circuitry, power management circuitry, digital control and interface circuitry, and/or any other desired circuitry that operates on the radio-frequency signals transmitted and/or received by antenna 42. Each of the front end module components may be mounted to a common (shared) substrate such as a rigid printed circuit board substrate or flexible printed circuit substrate. If desired, the various front end module components may also be integrated into a single integrated circuit chip. If desired, amplifier circuitry 48 and/or other components in FEM 40 such as filter circuitry 44 may also be implemented as part of transceiver circuitry 28.

Filter circuitry 44, switching circuitry 46, amplifier circuitry 48, and other circuitry may be disposed along radio-frequency transmission line path 36, may be incorporated into FEM 40, and/or may be incorporated into antenna 42 (e.g., to support antenna tuning, to support operation in desired frequency bands, etc.). These components, sometimes referred to herein as antenna tuning components, may be adjusted (e.g., using control circuitry 14) to tune the frequency response and wireless performance of antenna 42 over time.

Transceiver circuitry 28 may be separate from front end module 40. For example, transceiver circuitry 28 may be formed on another substrate such as the main logic board of device 10, a rigid printed circuit board, or flexible printed circuit that is not a part of front end module 40. Although control circuitry 14 is shown separately from wireless circuitry 24 in the example of FIG. 1 for the sake of clarity, wireless circuitry 24 may include processing circuitry that forms a part of processing circuitry 18 and/or storage circuitry that forms a part of storage circuitry 16 of control circuitry 14 (e.g., portions of control circuitry 14 may be implemented on wireless circuitry 24). As an example, processing circuitry 26 and/or portions of transceiver circuitry 28 (e.g., a host processor on transceiver 28) may form a part of control circuitry 14. Control circuitry 14 (e.g., portions of control circuitry 14 formed on processing circuitry 26, portions of control circuitry 14 formed on transceiver 28, and/or portions of control circuitry 14 that are separate from wireless circuitry 24) may provide control signals (e.g., over one or more control paths in device 10) that control the operation of front end module 40.

Transceiver circuitry 28 may include wireless local area network transceiver circuitry that handles WLAN communications bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network transceiver circuitry that handles the 2.4 GHz Bluetooth® band or other WPAN communications bands, cellular telephone transceiver circuitry that handles cellular telephone bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, 6G bands above 100 GHz, etc.), near-field communications (NFC) transceiver circuitry that handles near-field communications bands (e.g., at 13.56 MHz), satellite navigation receiver circuitry that handles satellite navigation bands (e.g., a GPS band from 1565 to 1610 MHz, a Global Navigation Satellite System (GLONASS) band, a BeiDou Navigation Satellite System (BDS) band, etc.), ultra-wideband (UWB) transceiver circuitry that handles communications using the IEEE 802.15.4 protocol and/or other ultra-wideband or impulse-based communications protocols, and/or any other desired radio-frequency transceiver circuitry for covering any other desired communications bands of interest.

Antenna 42 may be formed using any desired antenna structures. For example, antenna 42 may be an antenna with a resonating element that is formed from loop antenna structures, patch antenna structures, inverted-F antenna structures, slot antenna structures, planar inverted-F antenna structures, helical antenna structures, monopole antennas, dipoles, hybrids of these designs, etc. Two or more antennas 42 may be arranged into one or more phased antenna arrays (e.g., for conveying radio-frequency signals at millimeter wave frequencies). Parasitic elements may be included in antenna 42 to adjust antenna performance. Antenna 42 may be provided with a conductive cavity that backs the antenna resonating element of antenna 42 (e.g., antenna 42 may be a cavity-backed antenna such as a cavity-backed slot antenna).

The term “convey radio-frequency signals” as used herein means the transmission and/or reception of the radio-frequency signals (e.g., for performing unidirectional and/or bidirectional wireless communications with external wireless communications equipment). Antennas 42 may transmit the radio-frequency signals by radiating the radio-frequency signals into free space (or to free space through intervening device structures such as a dielectric cover layer). Antennas 42 may additionally, or alternatively, receive the radio-frequency signals from free space (e.g., through intervening devices structures such as a dielectric cover layer). The transmission and reception of radio-frequency signals by antennas 42 each involve the excitation or resonance of antenna currents on an antenna resonating element in the antenna by the radio-frequency signals within the frequency band(s) of operation of the antenna.

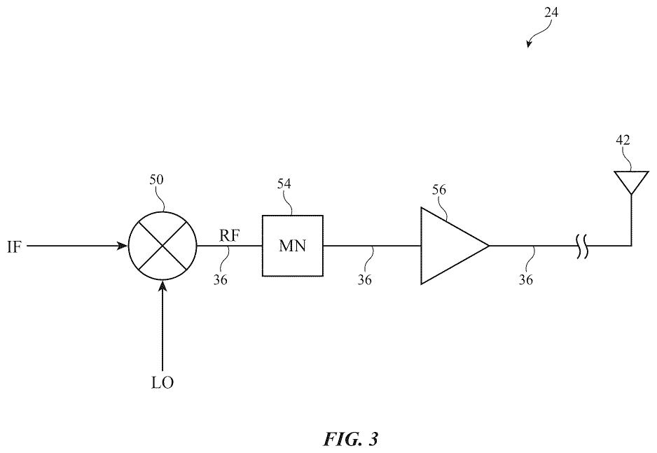

Wireless circuitry 24 may include a transmit (TX) path (sometimes also referred to as a TX chain) from processing circuitry 26 to antenna 42. The TX path may include, for example, baseband circuitry (e.g., in processing circuitry 26), transmitter circuitry (e.g., in transceiver circuitry 28) that includes one or more mixers in mixer circuitry 50, optionally FEM components in FEM 40, and a corresponding antenna 42 that are communicatively coupled together by path 34 and radio-frequency transmission line path 36. FIG. 3 is a circuit diagram showing one example of a transmit path in wireless circuitry 24.

As shown in FIG. 3, the transmit path in wireless circuitry 24 may include mixer circuitry 50 (e.g., one or more upconverting mixers), impedance matching circuitry such as impedance matching network (MN) 54, and amplifier circuitry such as amplifier 56 (e.g., a power amplifier). Mixer circuitry 50 may have a first (signal) input that receives, during signal transmission, a transmit signal at a first frequency such as an intermediate frequency (IF). Mixer circuitry 50 may have a second (clock) input that receives a clock signal such as local oscillator signal LO (e.g., from local oscillator circuitry 52 of FIG. 2). Local oscillator signal LO may be received by mixer circuitry 50 at a corresponding local oscillator frequency fLO.

During signal transmission, mixer circuitry 50 may mix the transmit signal with local oscillator signal LO to produce, at its output, an upconverted transmit signal such as a radio-frequency signal at a corresponding radio frequency (RF) (e.g., effectively upconverting the transmit signal from intermediate frequency IF to radio frequency RF). In this example, intermediate frequency IF is at a higher frequency than baseband and a lower frequency than radio frequency RF (e.g., intermediate frequency IF may be between around 1 kHz and around 700 MHz-10 GHz). Use of an intermediate frequency signal may, for example, help to minimize propagation loss between the baseband circuitry and the antenna in device 10, particularly when radio frequency RF is relatively high and thus subject to increased attenuation levels (e.g., when radio frequency RF is greater than around 6-20 GHz, at millimeter/centimeter wave frequencies, etc.). This example is illustrative and non-limiting. If desired, in any of the embodiments described herein, the intermediate frequency signal at intermediate frequency IF may be replaced with a baseband signal at a baseband frequency and mixer circuitry 50 may upconvert the baseband signal to an intermediate frequency (e.g., outputting a corresponding intermediate frequency signal instead of a radio frequency signal, such that the radio-frequency signal at radio frequency RF is replaced with an intermediate frequency in any of the embodiments herein) or may upconvert the baseband signal directly to radio frequency RF.

Mixer circuitry 50 may have a signal output coupled to radio-frequency transmission line path 36. Radio-frequency transmission line path 36 may couple the output of mixer circuitry 50 to antenna 42. Impedance matching network 54 and amplifier 56 may be disposed on radio-frequency transmission line path 36 between mixer circuitry 50 and antenna 42. Impedance matching network 54 may, for example, form an output impedance matching network or load for mixer circuitry 50 and/or an input impedance matching network or load for amplifier 56. Although impedance matching network 54 is shown as a separate component from mixer circuitry 50 in the example of FIG. 3 for the sake of illustration, impedance matching network 54 may be integrated into mixer circuitry 50 if desired (e.g., as an output impedance matching network of mixer circuitry 50).

A first segment of radio-frequency transmission line path 36 (e.g., one or more transmission lines) may couple the output of mixer circuitry 50 to the input of impedance matching network 54. A second segment of radio-frequency transmission line path 36 (e.g., one or more transmission lines) may couple the output of impedance matching network 54 to the input of amplifier 56. A third segment of radio-frequency transmission line path 36 (e.g., one or more transmission lines) may couple the output of amplifier 56 to antenna 42. Amplifier circuitry 56 as described herein may be replaced with any desired signal transmission circuitry or blocks (e.g., in transceiver circuitry 28 or FEM 40 of FIG. 2). If desired, additional components (e.g., from transceiver circuitry 28 and/or FEM 40 of FIG. 2) may be disposed on radio-frequency transmission line path 36 between impedance matching network 54 and antenna 42.

If desired, mixer circuitry 50 may generate the radio-frequency signal on radio-frequency transmission line path 36 using either high side injection (HSI) or low side injection (LSI). When performing upconversion using HSI, the frequency fLO of the local oscillator signal LO received by mixer circuitry 50 is greater than the radio frequency RF of the radio-frequency signal output by mixer circuitry 50. On the other hand, when performing upconversion using LSI, the frequency fLO of the local oscillator signal LO received by mixer circuitry 50 is lower than the radio frequency RF of the radio-frequency signal output by mixer circuitry 50. In practice, performing signal transmission using LSI may consume less power than performing signal transmission using HSI due to the lower frequency of local oscillator signal LO. However, in LSI transceivers, a second order harmonic of the local oscillator signal can create undesired in-band emissions or can produce edge emission without sufficient radio-frequency rejection later in the transmit path, which can limit and/or deteriorate the performance of wireless circuitry 24 in transmitting radio-frequency signals.

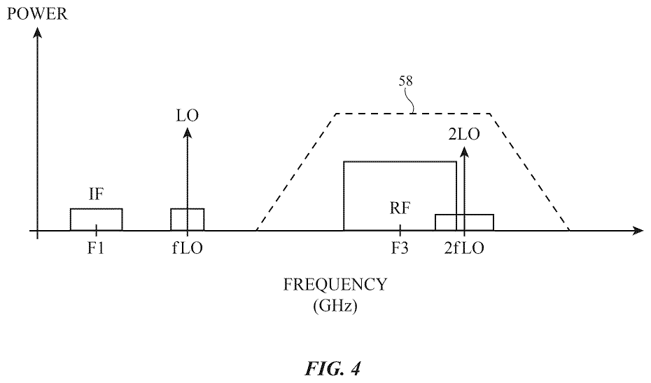

FIG. 4 is a frequency diagram showing how operating mixer circuitry 50 in an LSI mode can produce second order harmonic power that limits the signal transmission performance of wireless circuitry 24. As shown in FIG. 3, mixer circuitry 50 may receive an intermediate frequency signal at frequency F1 (e.g., with non-zero signal power around intermediate frequency IF) and a local oscillator signal LO at frequency fLO. Mixer circuitry 50 uses local oscillator signal LO to upconvert the intermediate frequency signal to a radio-frequency signal at frequency F3 (e.g., with non-zero signal power around radio frequency RF). Because mixer circuitry 50 implements LSI in this example, frequency F3 (e.g., radio frequency RF) is greater than frequency fLO of local oscillator signal LO. As one example, frequency F1 may be around 10 GHz, frequency fLO may be around 14 GHz, frequency F3 may be around 24 GHz, and frequency 2fLO may be around 28 GHz. This is non-limiting and, in general, frequencies F1, fLO, F3, and 2fLO may be any desired frequencies.

At the same time, mixer circuitry 50 may output non-zero power around frequency 2fLO, which is produced from the second order harmonic of local oscillator signal LO at frequency fLO. The second order harmonic of local oscillator signal LO (at frequency 2fLO) is sometimes also referred to herein as second order harmonic 2LO, second harmonic 2LO, second order local oscillator harmonic 2LO, second local oscillator harmonic 2LO, or simply as 2LO. If this second order harmonic emission is not suppressed, the emitted power at frequency 2fLO can fall in-band and overlap with the emitted power of the radio-frequency signal around frequency F3 (as shown in FIG. 3), which can introduce errors in the wireless data carried by the radio-frequency signal (e.g., degrading the error vector magnitude (EVM) of the radio-frequency signal). Even if the second order harmonic emission does not overlap with the emitted power of the radio-frequency signal around frequency F3 (e.g., is out-of-band), the second order harmonic emission can still violate (exceed) an emissions mask 58 imposed on the transmission of the radio-frequency signals (e.g., by a regulatory body or authority, a radio-frequency filter in the transmit path, etc.) if the emission is not sufficiently suppressed.

In some scenarios, the output load of mixer circuitry 50 can be monitored with an external spectrum analyzer (e.g., external to device 10) and then trimmed based on measurements from the external spectrum analyzer to minimize 2LO emission at the mixer output. However, external spectrum analyzers are bulky (e.g., unsuitable for implementation within a compact electronic device), expensive, and can cause the mixer circuitry to take an excessive amount of time to trim out the 2LO emission. In addition, this type of trimming is still sensitive to LO frequency, process, and temperature variations. In implementations that are described herein, the transmit path may include a negative feedback loop that is coupled between the input of amplifier 56 and impedance matching network 54 and that is used to suppress, reject, cancel, reduce, and/or minimize 2LO emissions in the transmitted signal without use of an external spectrum analyzer.

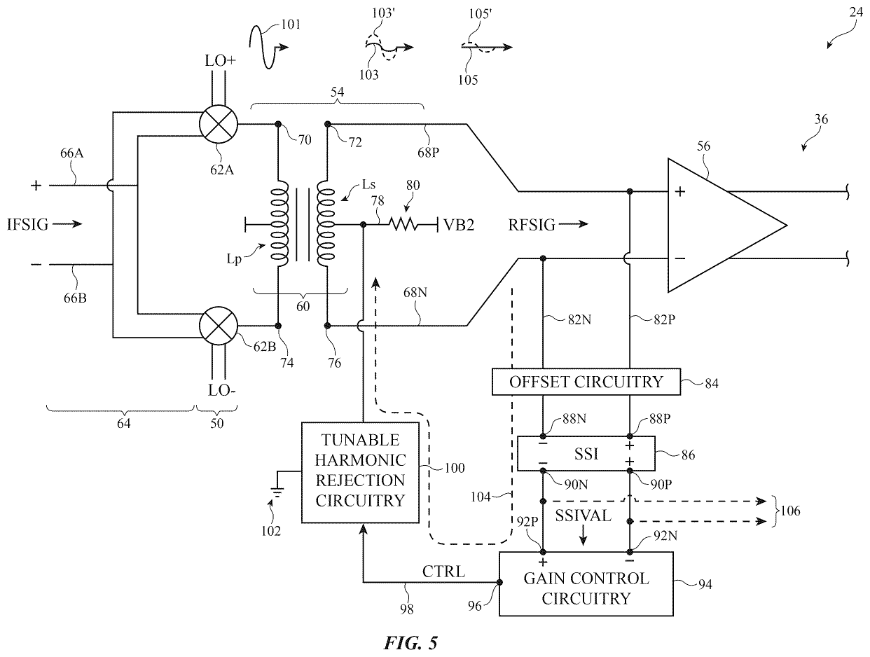

FIG. 5 is a circuit diagram showing one example of how the transmit path in wireless circuitry 24 (e.g., in a transmitter of transceiver circuitry 28 of FIG. 2) may include a negative feedback loop for suppressing, rejecting, canceling, reducing, and/or minimizing 2LO emissions (e.g., without use of an external spectrum analyzer). As shown in FIG. 5, the signal input of mixer circuitry 50 may be coupled to signal path 64. Signal path 64 may be, for example, an intermediate frequency signal path (e.g., a radio-frequency transmission line path) that carries a corresponding intermediate frequency signal IFSIG during transmission. This is illustrative and, in other implementations, signal path 64 may be a baseband path that carries a baseband signal.

In the example of FIG. 5, signal path 64 is a differential signal path that includes a first (e.g., positive) signal line 66A and a second (e.g., negative) signal line 66B that carry intermediate frequency signal IFSIG. This is illustrative and non-limiting and, in general, signal path 64 may include any desired signal lines for conveying intermediate frequency signal IFSIG (e.g., an in-phase and quadrature-phase (I/Q) path, a single ended signal path, etc.). Intermediate frequency signal IFSIG may be replaced with a baseband signal or any other desired signal that is upconverted using mixer circuitry 50, if desired.

Mixer circuitry 50 may include a first mixer 62A and a second mixer 62B (e.g., one or more mixer quads of transistors). Mixer 62A (sometimes also referred to herein as mixer circuit 62A) may have a signal input that is coupled to signal path 64 and that receives intermediate frequency signal IFSIG. Mixer 62B (sometimes also referred to herein as mixer circuit 62B) may also have a signal input that is coupled to signal path 64 and that concurrently receives intermediate frequency signal IFSIG. Mixer 62A may have a clock (local oscillator) input that receives a first polarity of local oscillator signal LO, denoted as local oscillator signal LO+. Mixer 62B may have a clock (local oscillator) input that concurrently receives a second polarity of local oscillator signal LO, denoted as local oscillator signal LO−. Local oscillator signal LO− may be an inverse of local oscillator signal LO+. Local oscillator signals LO− and LO+ may, for example, collectively form local oscillator signal LO of FIG. 3. Mixer circuitry 50 may receive local oscillator signals LO− and LO+ from local oscillator circuitry 52 (FIG. 2).

Radio-frequency transmission line path 36 may include a first signal line 68P and a second signal line 68N. Signal line 68P may be, for example, a positive signal line of radio-frequency transmission line path 36 and signal line 68N may be a negative, reference, or ground signal line of radio-frequency transmission line path 36. In some implementations, signal lines 68P and 68N may form a differential pair of signal lines for conveying differential signals, if desired. Impedance matching network 54 may couple the outputs of mixers 62A and 62B to signal lines 68P and 68N. Amplifier 56 may be disposed on radio-frequency transmission line path 36. Signal line 68P may be coupled to a first (e.g., positive) input terminal of amplifier 56. Signal line 68N may be coupled to a second (e.g., negative) input terminal of amplifier 56.

As shown in FIG. 5, impedance matching network 54 may include a radio-frequency transformer such as transformer 60. Transformer 60 may include a first (primary) winding Lp and a second (secondary) winding Ls. Windings Lp and Ls are sometimes also referred to as coils or inductors of transformer 60. Primary winding Lp may be coupled in series between a first input terminal 70 and a second input terminal 74 of transformer 60. Secondary winding Ls may be coupled in series between a first output terminal 72 and a second output terminal 76 of transformer 60. Primary winding Lp may be magnetically coupled to secondary winding Ls with a corresponding magnetic coupling constant k. Input terminal 70 of transformer 60 may be coupled to the output of mixer 62A. Input terminal 74 of transformer 60 may be coupled to the output of mixer 62B. Output terminal 72 of transformer 60 may be coupled to signal line 68P. Output terminal 76 of transformer 60 may be coupled to signal line 68N.

Secondary winding Ls of transformer 60 may have a center tap 78. Center tap 78 is sometimes also referred to herein as the center tap conductor, center tap contact, or center tap terminal of secondary winding Ls. Center tap 78 may be coupled to a corresponding bias voltage VB2 (e.g., a reference potential, ground, or another bias voltage). If desired, transformer 60 may include a center tap resistor 80 coupled in series between center tap 78 and bias voltage VB2 (e.g., resistor 80 may couple center tap 78 to bias voltage VB2 and bias voltage VB2 may be applied to the center tap of secondary winding Ls through resistor 80). If desired, primary winding Lp of transformer 60 may also have a corresponding center tap that is coupled to a corresponding bias voltage. A first segment or portion of secondary winding Ls may extend from center tap 78 to output terminal 72 and a second segment or portion of secondary winding Ls may extend from center tap 78 to output terminal 76. If desired, the first segment may have the same length as the second segment (e.g., each including one or more turns, more than a half of a turn, or more than a quarter of a turn of conductive material such as conductive traces on an underlying substrate). Alternatively, the second segment may have a different length than the first segment (e.g., center tap 78 need not be located exactly at the center of secondary winding Ls, if desired).

During signal transmission, mixer 62A may mix intermediate frequency signal IFSIG (e.g., at frequency F1 of FIG. 4) with local oscillator signal LO+ (e.g., at frequency fLO of FIG. 4) to produce a first upconverted signal at its output (e.g., a first radio-frequency voltage at input terminal 70 of transformer 60). At the same time, mixer 62B may mix intermediate frequency signal IFSIG with local oscillator signal LO− (e.g., at frequency fLO of FIG. 4) to produce a second upconverted signal at its output (e.g., a second radio-frequency voltage at input terminal 74 of transformer 60). The first and second upconverted signals output by mixer circuitry 50 may collectively form radio-frequency signal RFSIG (e.g., a voltage signal between input terminals 70 and 74 of transformer 60, at frequency F3 of FIG. 4). Transformer 60 may form an output impedance load that performs impedance matching between mixer circuitry 50 and signal lines 68P/68N and may pass radio-frequency signal RFSIG onto signal lines 68P/68N. Amplifier 56 may amplify radio-frequency signal RFSIG and may transmit the amplified radio-frequency signal to a corresponding antenna 42 (FIG. 3).

When mixer circuitry 50 performs upconversion using LSI, the second order harmonic of local oscillator signals LO+/LO− may cause radio-frequency signal RFSIG to exhibit a relatively high common mode (CM) 2LO component at the output of mixer circuitry 50 may, as shown by waveform 101. In the absence of 2LO suppression, a relatively high amount of this CM 2LO component may leak onto signal lines 68P/68N through transformer 60, as shown by waveform 103′. In addition, there may also be a non-zero amount of common mode to differential mode (DM) leakage of the 2LO component onto signal lines 68P/68N, shown by waveform 105′. If care is not taken, these 2LO components can overlap the frequency band of the transmitted radio-frequency signal RFSIG, degrading the EVM of the radio-frequency signal RFSIG transmitted over the transmit path, and/or may violate emissions mask 58 (FIG. 4), and/or may violate the emissions mask associated with signal transmission.

To mitigate these issues, the transmit path may also include signal strength indicator (SSI) measurement circuitry 86, gain control circuitry 94, and tunable harmonic rejection circuitry 100 coupled in a negative feedback loop path extending from signal lines 68N/68P (e.g., the input of amplifier 56) to the secondary inductor Ls (e.g., center tap 78) in transformer 60. As shown in FIG. 5, SSI measurement circuitry 86 may have a first input terminal 88P, a second input terminal 88N, a first output terminal 90N, and a second output terminal 90P. Input terminal 88P may have a first (e.g., positive) polarity and is sometimes also referred to herein as positive input terminal 88P. Output terminal 90P may have the first (e.g., positive) polarity and is sometimes also referred to herein as positive output terminal 90P. Input terminal 88N may have a second (e.g., negative) polarity and is sometimes also referred to herein as negative input terminal 88N. Output terminal 90N may have the second (e.g., negative) polarity and is sometimes also referred to herein as negative output terminal 90N. Input terminals 88P/88N of SSI measurement circuitry 86 are sometimes also referred to herein as input ports 88P/88N, input taps 88P/88N, or simply as inputs 88P/88N of SSI measurement circuitry 86. Output terminals 90P/90N of SSI measurement circuitry 86 are sometimes also referred to herein as output ports 90P/90N or simply as outputs 90P/90N of SSI measurement circuitry 86.

Positive input terminal 88P of SSI measurement circuitry 86 may be coupled to signal line 68P over a corresponding signal line 82P (e.g., a signal line of the first polarity such as a positive signal line). Negative input terminal 88N of SSI measurement circuitry 86 may be coupled to signal line 68N over a corresponding signal line 82N (e.g., a signal line of the second polarity such as a positive signal line). Signal line 82P may, for example, be coupled to the positive input terminal of amplifier 56, output terminal 72 of transformer 60, and/or to a first node on signal line 68P between output terminal 72 and the positive input terminal of amplifier 56. Signal line 82N may, for example, be coupled to the negative input terminal of amplifier 56, output terminal 76 of transformer 60, and/or to a second node on signal line 68N between output terminal 76 and the negative input terminal of amplifier 56. If desired, the first and/or second nodes may include radio-frequency signal splitters and/or radio-frequency signal couplers.

If desired, offset circuitry 84 may be disposed on signal lines 82N/82P between the input SSI measurement circuitry 86 and signal lines 68P/68N. Offset circuitry 84 may also be incorporated into the input of SSI measurement circuitry 86 or may be omitted if desired. Gain control circuitry 94 may have a first input terminal 92P, a second input terminal 92N, and an output terminal 96. Input terminal 92P may have the first (e.g., positive) polarity and is sometimes also referred to herein as positive input terminal 92P. Input terminal 92N may have the second (e.g., negative) polarity and is sometimes also referred to herein as negative input terminal 92N. Input terminals 92P/92N of gain control circuitry 94 are sometimes also referred to herein as input ports 92P/92N or simply as inputs 92P/92N of gain control circuitry 94. Output terminal 96 is sometimes also referred to herein as output port 96 or simply as output 96 of gain control circuitry 94. Gain control circuitry 94 is sometimes also referred to herein as gain controller 94 or a controller (e.g., control circuitry) for tunable harmonic rejection circuitry 100.

Output terminal 96 of gain control circuitry 94 may be coupled to one or more control inputs, ports, or terminals of tunable harmonic rejection circuitry 100 over control path 98. Tunable harmonic rejection circuitry 100 may be coupled to center tap 78 of the secondary winding Ls of transformer 60. If desired, one or more terminals of tunable harmonic rejection circuitry 100 may be coupled to reference potential 102 (e.g., ground or another reference potential). Tunable harmonic rejection circuitry 100 may, for example, be coupled between center tap 78 of secondary winding Ls and reference potential 102 (e.g., tunable harmonic rejection circuitry 100 may couple center tap 78 to reference potential 102 and may form a tunable shunt path between center tap 78 and reference potential 102).

Offset circuitry 84, SSI measurement circuitry 86, gain control circuitry 94, and tunable harmonic rejection circuitry 100 may collectively form a feedback path 104 coupled between signal lines 68P/68N (e.g., the segment of radio-frequency transmission line path 36 between amplifier 56 and transformer 60) and center tap 78 of secondary winding Ls. Feedback path 104 may be implemented as a negative feedback path by coupling the output terminals 90N/90P of SSI measurement circuitry 86 to the input terminals 92P/92N of gain control circuitry 94 with reverse polarity. For example, as shown in FIG. 5, negative output terminal 90N of SSI measurement circuitry 86 may be coupled to positive input terminal 92P of gain control circuitry 94. Similarly, positive output terminal 90P of SSI measurement circuitry 86 may be coupled to negative input terminal 92N of gain control circuitry 94. Feedback path 104 is sometimes also referred to herein as negative feedback path 104, feedback loop 104, or negative feedback loop 104. If desired, output terminals 90P/90N of SSI measurement circuitry 86 may also be coupled to an optional SSI output path 106. Output path 106 may couple the output of SSI measurement circuitry 86 to additional control and/or processing circuitry in device 10 (e.g., processing circuitry 18 of FIG. 1). Output path 106 may be omitted if desired.

If desired, switching circuitry (not shown in FIG. 5 for the sake of clarity) such as one or more switches may be disposed on signal lines 82N and 82P to selectively activate or deactivate feedback path 104 (e.g., the switching circuitry may form an open circuit impedance or greater than a threshold impedance in feedback path 104 when feedback path 104 is inactive, disabled, or switched off, and may form a short circuit impedance or less than a threshold impedance in feedback path 104 when feedback path 104 is active, disabled, or switched on). The switching circuitry may be located elsewhere in feedback path 104 if desired (e.g., between SSI measurement circuitry 86 and gain control circuitry 94, within gain control circuitry 94, on control path 98, etc.). Additionally, or alternatively, one or more control signals and/or power supply voltages may be provided to offset circuitry 84, SSI measurement circuitry 86, and/or gain control circuitry 94 to power on, activate, and/or enable one or more of these components when feedback path 104 is active and to power off, deactivate, and/or disable one or more of these components when feedback path 104 is inactive. Feedback path 104 is sometimes also referred to as being closed when feedback path 104 is active, turned on, or enabled. Feedback path 104 is sometimes also referred to as being open or opened when feedback path 104 is inactive, turned off, or disabled.

SSI measurement circuitry 86 may measure (sense) one or more properties of a signal on signal lines 68P/68N (e.g., radio-frequency signal RFSIG or another signal when intermediate frequency signal IFSIG is not being provided to mixer circuitry 50). SSI measurement circuitry 86 may, for example, measure one or more metrics associated with the peak voltage level of the signal. In some implementations that are described herein as an example, SSI measurement circuitry 86 may measure SSI values (e.g., transmit signal strength indicator (TSSI) values) of the signal, values associated with or proportional to the magnitude of the difference in voltage or peak voltage between signal lines 68P and 68N, etc. SSI measurement circuitry 86 may include, for example, one or more voltage peak detectors (sensors) that perform measurements on the signal (e.g., measurements of the differential voltage and/or peak differential voltages between signal lines 68P and 68N). SSI measurement circuitry 86 is sometimes also referred to herein as SSI sensor 86, SSI circuitry 86, TSSI circuitry 86, TSSI measurement circuitry 86, TSSI sensor 86, voltage peak detection circuitry 86, voltage peak detector 86, or voltage peak sensor 86. SSI measurement circuitry 86 may be implemented using any desired analog circuit components and consumes substantially less space, power, and cost than an external spectrum analyzer.

SSI measurement circuitry 86 may output a signal that represents, characterizes, includes, indicates, or otherwise identifies the measurements performed by SSI measurement circuitry 86 of the signal on signal lines 68P/68N. This signal is sometimes also referred to herein as output signal SSIVAL (e.g., an analog signal having a time-varying magnitude that represents the SSI or peak voltage magnitude of the signal on signal lines 68P/68N over time). Output signal SSIVAL may, for example, be represented by the voltage difference between output terminals 90N and 90P of SSI measurement circuitry 86. If desired, SSI measurement circuitry 86 may provide output signal SSIVAL to other processing circuitry over output path 106. The other processing circuitry may, for example, use output signal SSIVAL to identify the SSI of the transmitted radio-frequency signal RFSIG and may use this information to characterize the performance of the transmit path in real time and/or to adjust one or more properties of the transmit path (e.g., amplifier gains, filter settings, power supply voltages, antenna tuning settings, impedance matching settings, predistortion settings, envelope tracking settings, etc.) based on output signal SSIVAL (e.g., in a manner that optimizes wireless performance given the current SSI of the transmitted signal).

SSI measurement circuitry 86 may also provide output signal SSIVAL to input terminals 92P/92N of gain control circuitry 94. The reversed polarity between input terminals 92P/92N of gain control circuitry 94 and output terminals 90N/90P of SSI measurement circuitry 86 may cause gain control circuitry 94 to receive an inverted version of the output signal SSIVAL generated by SSI measurement circuitry 86 at output terminals 90N/90P (e.g., configuring feedback path 104 to form a negative feedback path). Gain control circuitry 94 may serve to provide a desired amount of gain to feedback path 104. Gain control circuitry 94 may generate a control signal CTRL on control path 98 based on the output signal SSIVAL received at its input terminals 92P/92N. Tunable harmonic rejection circuitry 100 may include tunable/adjustable circuit components (e.g., adjustable capacitors, inductors, resistors, etc.) that configure tunable harmonic rejection circuitry 100 to or exhibit a tunable (adjustable or switchable) impedance. In some implementations that are described herein as an example, tunable harmonic rejection circuitry 100 may include one or more adjustable capacitors. The adjustable capacitor(s) may include adjustable analog varactors and/or digitally adjustable banks of switchable capacitors. Gain control circuitry 94 may supply control signal CTRL to tunable harmonic rejection circuitry 100 over control path 98 to set and/or adjust a state of tunable harmonic rejection circuitry 100. Control signal CTRL may, for example, adjust one or more of the circuit components in tunable harmonic rejection circuitry 100 to configure or set tunable harmonic rejection circuitry 100 to impart a desired impedance on center tap 78 of secondary inductor Ls (e.g., a shunt impedance to reference potential 102). Tunable harmonic rejection circuitry 100 is sometimes also referred to herein as adjustable harmonic rejection circuitry 100, tunable harmonic suppression circuitry 100, adjustable harmonic suppression circuitry 100, adjustable second order harmonic mitigation circuitry 100, adjustable circuit 100, or adjustable 2LO suppression, rejection, or mitigation circuitry 100.

In some implementations, gain control circuitry 94 may include analog circuitry that outputs control signal CTRL as an analog control signal (e.g., a control voltage or current) on control path 98 (e.g., control path 98 may be an analog control path). In other implementations, gain control circuitry 94 may include digital circuitry that outputs control signal CTRL as a digital control signal (e.g., a digital code containing a series of one or more control bits) on control path 98 (e.g., control path 98 may be a digital control path). Gain control circuitry 94 may control tunable harmonic rejection circuitry 100 based on the output signal SSIVAL received from SSI measurement circuitry 86 in a manner that causes harmonic rejection circuitry 100 to trim out and minimize the presence of 2LO emission in the radio-frequency signal RFSIG on signal lines 68P/68N. If desired, offset circuitry 84 may apply a voltage offset to the signal provided to SSI measurement circuitry 86 to help cancel out a DC offset of SSI measurement circuitry 86.

As one example, SSI measurement circuitry 86 may measure the signal on signal lines 68P/68N during a first time period when mixer circuitry 50 receives local oscillator signal LO but while intermediate frequency IFSIG is turned off (e.g., while the signal inputs of mixer circuitry 50 do not receive a signal), producing a corresponding output signal SSIVAL. The output signal SSIVAL generated by SSI measurement circuitry 86 during this first time period may include, represent, identify, and/or characterize the amount of 2LO emission produced by mixer circuitry 50 while clocked using local oscillator signal LO at a corresponding frequency fLO. The output signal SSIVAL is then fed back to tunable harmonic rejection circuitry 100 via gain control circuitry 94 and control signal CTRL (e.g., in a negative feedback loop). Control signal CTRL may adjust the capacitance of tunable harmonic rejection circuitry 100 (sometimes also referred to herein as capacitance Cc), and thus the capacitance between center tap 78 of secondary winding Ls and reference potential 102, until the capacitance is equal to an optimal capacitance that causes transformer 60 to suppress the 2LO emission at frequency 2fLO (e.g., for the current frequency fLO of local oscillator signal LO).

When tunable harmonic rejection circuitry 100 is tuned to the optimal capacitance for the current frequency fLO of local oscillator signal LO (e.g., during a second time period after the first time period), there may be substantially no 2LO voltage swing across at the input of SSI measurement circuitry 86 and the output signal SSIVAL from SSI measurement circuitry 86 converges to a differential output voltage with a magnitude of zero. The negative feedback loop may, for example, serve to minimize the differential output voltage of SSI measurement circuitry 86 over time (e.g., by adjusting the capacitance of tunable harmonic rejection circuitry 100 to a new optimal capacitance for each frequency fLO of local oscillator signal LO that is used over time). If desired, offset circuitry 84 may serve to cancel out the DC offset of SSI measurement circuitry 86 prior to closing feedback path 104.

In this way, transformer 60 may effectively reduce (suppress) the CM 2LO component of the radio-frequency signal RFSIG output by mixer circuitry 50 (e.g., causing the radio-frequency signal RFSIG on signal lines 68P/68N to have a CM 2LO component as shown by waveform 103, which is of lower peak voltage level than waveform 103′ associated with the absence of 2LO suppression). In addition, transformer 60 may effectively reduce (suppress) the CM-to-DM 2LO component of the radio-frequency signal RFSIG output by mixer circuitry 50 (e.g., causing the radio-frequency signal RFSIG on signal lines 68P/68N to have a CM-to-DM 2LO component as shown by waveform 105, which is of lower peak voltage level than waveform 105′ associated with the absence of 2LO suppression). Utilizing feedback readings from SSI measurement circuitry 86 in this way may serve to suppress, reject, cancel, and/or mitigate 2LO emissions in the radio-frequency signal RFSIG supplied to the input of amplifier 56 without use of an external spectrum analyzer. In addition, feedback path 104 may also allow for background or offline calibration that monitors closely across frequency and temperature variations, helping to reduce overall trim time and providing a more reliable monitor and control for the trimming of transformer 60.

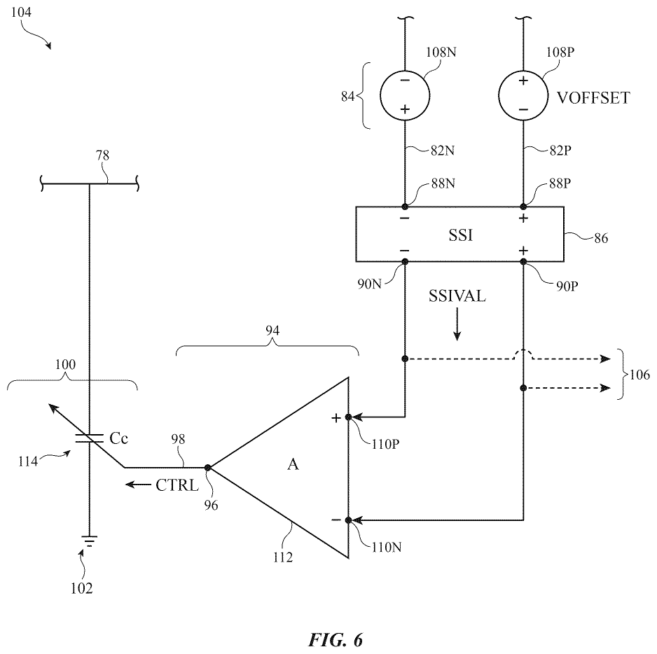

FIG. 6 is a circuit diagram showing one example of feedback path 104 in implementations where gain control circuitry 94 includes analog gain control circuitry. As shown in FIG. 6, gain control circuitry 94 may include an amplifier 112 (e.g., an operational amplifier) having a first (positive) input terminal 110P (e.g., forming positive input terminal 92P of FIG. 5) and having a second (negative) input terminal 110N (e.g., forming negative input terminal 92N of FIG. 5). In these implementations, tunable harmonic rejection circuitry 100 may include an adjustable capacitor 114 (e.g., an analog varactor). Adjustable capacitor 114 may exhibit a capacitance Cc that is adjusted by the magnitude of the control signal CTRL output by gain control circuitry 94.

When feedback path 104 is closed (e.g., while mixer circuitry 50 does not receive intermediate frequency signals IFSIG), amplifier 112 may amplify an inverted version of the output signal SSIVAL produced by SSI measurement circuitry to produce control signal CTRL (e.g., an analog control signal) with a corresponding magnitude. The magnitude of control signal CTRL may adjust capacitance Cc of adjustable capacitor 114 to a corresponding value. As signals loop through the feedback path, capacitance Cc may converge upon an optimal capacitance for tunable harmonic rejection circuitry 100 that suppresses 2LO emissions on signal lines 68P/68N (FIG. 5) for the current frequency fLO of local oscillator signal LO (e.g., as the magnitude of output signal SSIVAL or the differential voltage between output terminals 90N/90P of SSI measurement circuitry 86 converges to zero).

If desired, offset circuitry 84 may apply an offset voltage VOFFSET to the signal provided to SSI measurement circuitry 86 over signal lines 82P/82N (e.g., as coupled off of signal lines 68P/68N of FIG. 5). Offset circuitry 84 may include, for example, a first bias adjustment circuit 108N on signal line 82N and/or a second bias adjustment circuit 108P on signal line 82P. Bias adjustment circuits 108P/108N may, for example, apply an offset voltage VOFFSET to the voltage between signal lines 82N and 82P that cancels out a DC offset of SSI measurement circuitry 86. Bias adjustment circuits 108P/108N may, as one example, be implemented using one or more offset cancellation digital-to-analog converters (DACs) coupled to the input of SSI measurement circuitry 86. Offset circuitry 84 may, for example, apply offset voltage VOFFSET to remove the DC offset of SSI measurement circuitry 86 prior to turning on feedback path 104.

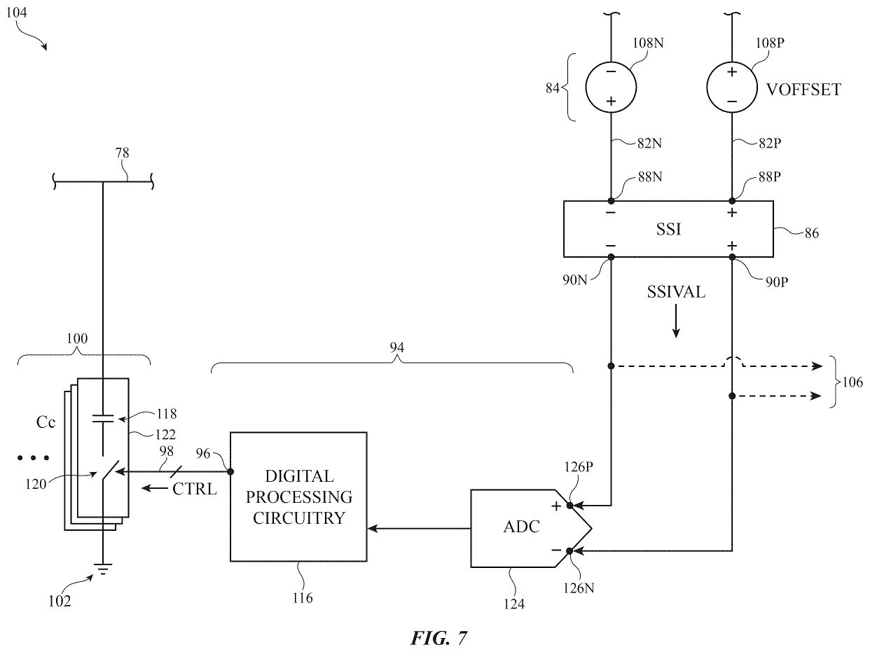

FIG. 7 is a circuit diagram showing another example of feedback path 104 in implementations where gain control circuitry 94 includes digital gain control circuitry. As shown in FIG. 7, gain control circuitry 94 may include an analog-to-digital converter (ADC) 124 and digital processing circuitry 116. ADC 124 may be coupled between SSI measurement circuitry 68 and digital processing circuitry 116. Digital processing circuitry 116 may be coupled between ADC 124 and tunable harmonic rejection circuitry 100.

ADC 124 may have a first (positive) input terminal 126P (e.g., forming positive input terminal 92P of FIG. 5) and a second (negative) input terminal 126N (e.g., forming negative input terminal 92N of FIG. 5). In these implementations, tunable harmonic rejection circuitry 100 may include digitally-controlled bank of switchable capacitors 122 coupled in series and/or in parallel between center tap 78 and reference potential 102. Each switchable capacitor 122 may include, for example, a corresponding fixed capacitor 118 and a corresponding switch 120. Switch 120 may be coupled in series between its capacitor 118 and reference potential 102. Capacitor 118 may be coupled in series between its switch 120 and center tap 78. Switches 120 may have control terminals that are coupled to control path 98. As one example, each switch 120 may include a single-pole single-throw switch (e.g., implemented using a transistor having a first source-drain terminal coupled to capacitor 118, a second source-drain terminal coupled to reference potential 102, and a gate terminal coupled to control path 98).

When feedback path 104 is closed (e.g., while mixer circuitry 50 does not receive intermediate frequency signals IFSIG), ADC 124 may receive output signal SSIVAL from SSI measurement circuitry 86 as an analog signal at its input terminals 126P/126N. ADC 124 may convert output signal SSIVAL into a corresponding digital signal (e.g., a digital code having a value corresponding to the magnitude of output signal SSIVAL). Digital processing circuitry 116 may process the digital signal output by ADC 124 (e.g., a digitized version of output signal SSIVAL) to generate control signal CTRL as a digital control signal on control path 98 (e.g., a digital path). Digital processing circuitry 116 may include one or more processors (e.g., a digital signal processor), digital logic gates, and/or any other desired digital circuitry that performs a digital processing and/or optimization algorithm on the digital signal output by ADC 124 to produce control signal CTRL (e.g., to convert the digital signal output by ADC 124 into a corresponding digital code in control signal CTRL that places switchable capacitors 122 into a corresponding setting). Control signal CTRL may adjust the switches 120 in switchable capacitors 122 to set the capacitance Cc of tunable harmonic rejection circuitry 100 to a corresponding value. The voltage offset VOFFSET imparted by offset circuitry 84 may, for example, help to improve the accuracy of the digital reading performed by gain control circuitry 94 (e.g., by removing the DC offset of SSI measurement circuitry 86). If desired, gain control circuitry 94 and/or tunable harmonic rejection circuitry 100 may be implemented using a combination of the analog circuitry of FIG. 6 and the digital circuitry of FIG. 7.

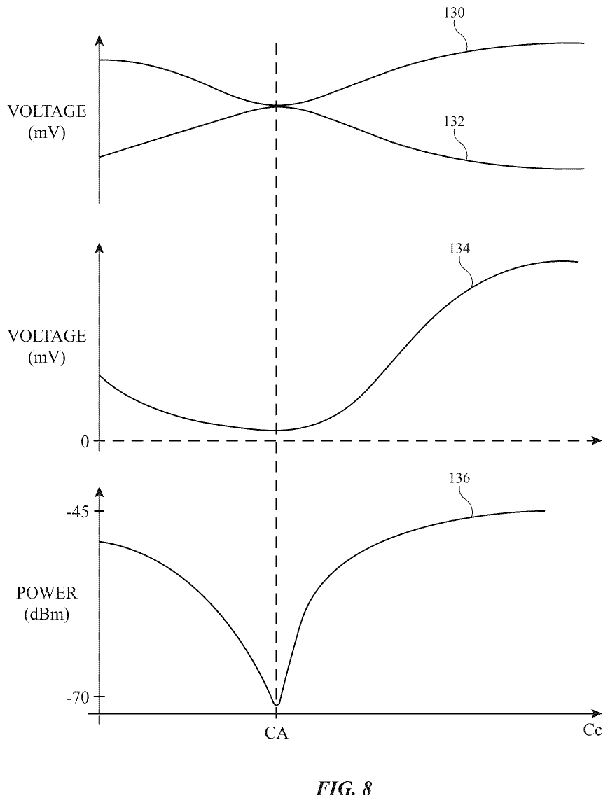

FIG. 8 is a plot showing how an optimal setting for the capacitance Cc of tunable harmonic rejection circuitry 100 may serve to minimize 2LO power in the radio-frequency signal RFSIG conveyed over signal lines 68P/68N (FIG. 5). Curve 130 of FIG. 8 plots the voltage at positive output terminal 90P of SSI measurement circuitry 86 as a function of the capacitance Cc of tunable harmonic rejection circuitry 100. Curve 132 plots the voltage at negative output terminal 90N of SSI measurement circuitry 86 as a function of the capacitance Cc of tunable harmonic rejection circuitry 100. Curve 134 plots the voltage of the output signal SSIVAL produced by SSI measurement circuitry 86 at its output terminals 90P/90N. Curve 134 is associated with the difference between curves 130 and 132 (e.g., the value of output signal SSIVAL may be given by the voltage difference between the output terminals 90P/90N of SSI measurement circuitry 86).

Curve 136 plots the output power of transformer 60 at the frequency 2fLO associated with 2LO emission produced by mixer circuitry 50 while clocked using local oscillator signal LO at frequency fLO. As shown by curve 136, when tunable harmonic rejection circuitry 100 has a capacitance Cc equal to value CA, the power of the 2LO emission is minimized. Value CA is sometimes also referred to herein as the optimal value of capacitance Cc (e.g., optimal capacitance CA), given the current frequency fLO of the local oscillator signal LO used to clock mixer circuitry 50. As shown by curves 130-134, optimal capacitance CA is associated with the minimization of output signal SSIVAL (e.g., where the voltage at positive output terminal 90P equals the voltage at negative output terminal 90N of SSI measurement circuitry 86). When feedback path 104 is closed, the negative feedback loop of feedback path 104 may, for example, serve to adjust the capacitance Cc of tunable harmonic rejection circuitry 100 until the voltage at positive output terminal 90P converges with the voltage at negative output terminal 90N of SSI measurement circuitry 86 (e.g., until the voltage of output signal SSIVAL converges to zero), at which point the capacitance Cc of tunable harmonic rejection circuitry 100 converges upon optimal capacitance CA and the power of 2LO emission is minimized, canceled, rejected, or mitigated. The example of FIG. 8 is illustrative and non-limiting. Curves 130-136 may have other shapes in practice.

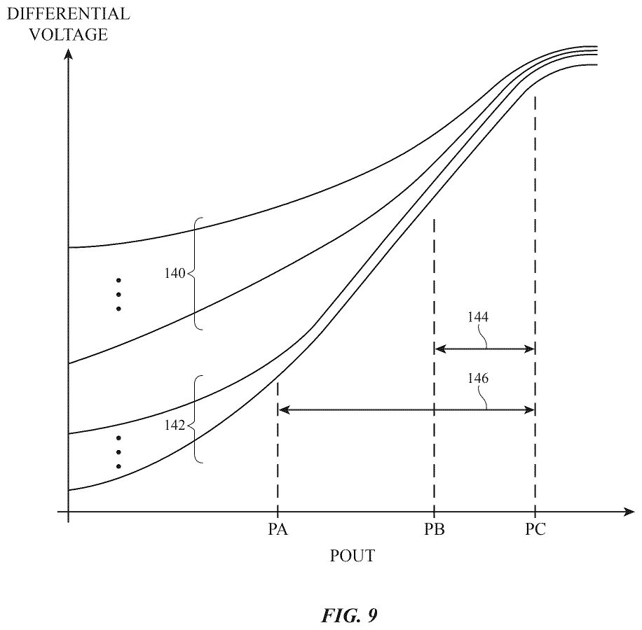

Processing circuitry 18 (FIG. 1) may perform any desired operations based on the output signal SSIVAL output by SSI measurement circuitry 86 over output path 106 of FIGS. 5-7 (e.g., based on the TSSI of the signal on signal lines 68P/68N of FIG. 5). In practice, feedback path 104 may serve to increase the dynamic range of the output signal SSIVAL output by SSI measurement circuitry 86, which may also serve to improve the performance of processing circuitry 18 in performing other operations based on output signal SSIVAL. FIG. 9 is a plot showing how feedback path 104 may serve to increase the dynamic range of output signal SSIVAL. The vertical axis of FIG. 9 plots the differential voltage of output signal SSIVAL (e.g., on a logarithmic scale). The horizontal axis of FIG. 9 plots the output power level Pout of mixer circuitry 50.

As shown in FIG. 9, curves 140 illustrate different values of output signal SSIVAL produced from a set of different signal transmissions in the absence of 2LO cancellation by feedback path 104. Curves 142 illustrate different values of output signal SSIVAL produced from a set of different signal transmissions while tunable harmonic rejection circuitry 100 cancels out 2LO emissions due to tunable harmonic rejection circuitry 100 exhibiting a corresponding optimal capacitance CA (e.g., as determined via feedback path 104). In practice, the substantially linear regions of output signal SSIVAL correspond to SSI measurements with sufficient fidelity for reliable use in subsequent processing. Curves 140 exhibit a substantially linear region for output power levels between power PB and power PC. The difference between power levels PC and PB defines the dynamic range 144 of output signal SSIVAL in the absence of 2LO cancellation. On the other hand, curves 142 exhibit a substantially linear region for output power levels between power PA and power PC. The difference between power levels PA and PC defines the dynamic range 144 of output signal SSIVAL with 2LO cancellation by feedback path 104. As shown in FIG. 9, the dynamic range 146 of output signal SSIVAL with 2LO cancellation is substantially larger than the dynamic range 144 of output signal SSIVAL without 2LO cancellation.

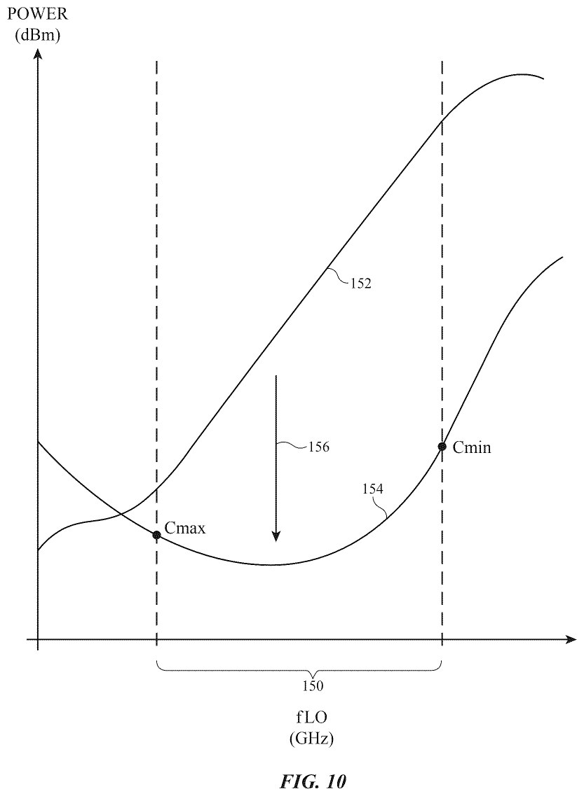

FIG. 10 is a plot that illustrates how the optimal capacitance CA of tunable harmonic rejection circuitry 100 may vary as the frequency fLO of the local oscillator signal LO provided to mixer circuitry 50 varies. As shown in FIG. 10, curve 152 plots the 2LO emission power of mixer circuitry 50 as a function of frequency fLO in the absence of feedback path 104 (e.g., in implementations where a fixed capacitance Cc is coupled to the center tap 78 of secondary winding Ls). Curve 154 plots the 2LO emission power of mixer circuitry 50 as a function of frequency fLO after feedback path 104 has performed 2LO emission cancellation.

Each point on curve 154 may, for example, correspond to the particular optimal capacitance CA of tunable harmonic rejection circuitry 100 across a range 150 of frequencies fLO for the local oscillator signal LO provided to mixer circuitry 50 (e.g., from a minimum optimal capacitance Cmin for a highest frequency fLO in range 150 to a maximum optimal capacitance Cmax for a lowest frequency fLO in range 150). As shown by curves 152 and 154, setting the capacitance Cc of tunable harmonic rejection circuitry 100 using feedback path 104 may serve to substantially reduce 2LO emission power for mixer circuitry 50 for all frequencies fLO across range 150. In practice, as shown by arrow 156, more iterations around feedback path 104 may serve to push the 2LO emission power for mixer circuitry 50 lower until converging upon curve 154. The optimal capacitances represented by curve 154 may be stored or recorded (e.g., in storage circuitry) for use during subsequent signal transmission operations (e.g., without needing to close the feedback loop during signal transmission).

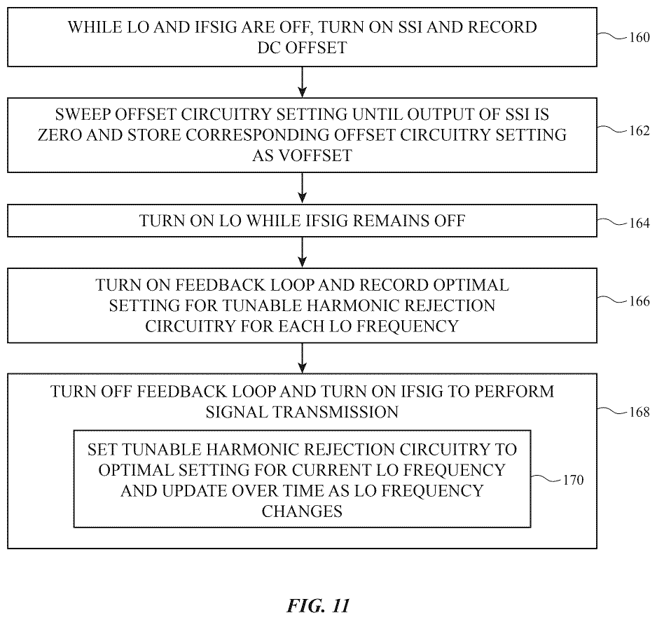

FIG. 11 is a flow chart of operations that may be performed by the transmit path of FIGS. 5-7 to remove 2LO emissions from a transmitted signal. At operation 160, control circuitry in wireless circuitry 24 (e.g., in processing circuitry 18 of FIG. 1) may turn on SSI measurement circuitry 86 while both intermediate frequency signal IFSIG and local oscillator LO are turned off (e.g., while mixer circuitry 50 receives neither an input signal nor a clock signal). Feedback path 104 may remain open while SSI measurement circuitry 86 is active. SSI measurement circuitry 86 may generate an output signal SSIVAL at this time that is representative of the DC offset of SSI measurement circuitry 86. This value of output signal SSIVAL may be stored (recorded) as the DC offset of SSI measurement circuitry 86 for use in later processing if desired.

At operation 162, offset circuitry 84 may sweep through different offset voltages VOFFSET applied to the input of SSI measurement circuitry 86 until the value of output signal SSIVAL drops to zero. The value of offset voltage VOFFSET that causes output signal SSIVAL to be zero (e.g., while both the intermediate frequency signal and the local oscillator signal are turned off) is equal to the DC offset of SSI measurement circuitry 86. This value of offset voltage VOFFSET may be stored (e.g., in offset circuitry 84) for use during subsequent operations. Offset circuitry 84 may, for example, apply this value of offset voltage VOFFSET to the signals provided to SSI measurement circuitry 86 during the remaining operations of FIG. 11. Operations 160-162 may be omitted if desired.

At operation 164, the control circuitry may turn on the local oscillator signal LO provided to mixer circuitry 50 while intermediate frequency signal IFSIG remains turned off (e.g., local oscillator circuitry 52 of FIG. 2 may begin to supply local oscillator signal LO to mixer circuitry 50 at a corresponding frequency fLO).

At operation 166, the control circuitry may turn on (close) feedback path 104 while mixer circuitry 50 is supplied with local oscillator signal LO but not a transmit signal (e.g., while intermediate frequency signal IFSIG remains off). Signal power provided to SSI measurement circuitry 86 during this time period may be dominated by 2LO emissions from mixer circuitry 50. Signals may loop through feedback path 104 to set the capacitance Cc of tunable harmonic rejection circuitry 100 to the optimal value CA for the current frequency fLO of local oscillator signal LO. This may occur, for example, when the output signal SSIVAL produced by SSI measurement circuitry 86 converges to zero (e.g., as shown in FIG. 8), corresponding to a cancelation, rejection, suppression, or mitigation of the 2LO emission produced by mixer circuitry 50.

If desired, local oscillator circuitry 52 of FIG. 2 may sweep local oscillator signal LO across a set of different frequencies fLO (e.g., across range 150 of FIG. 10) and feedback path 104 may generate or identify optimal values CA for tunable harmonic rejection circuitry 100 in this way for each of the different frequencies fLO of local oscillator signal LO (producing, e.g., curve 154 of FIG. 10). The range of different frequencies fLO may, for example, correspond to different desired carrier frequencies that are used to transmit radio-frequency signals RFSIG after the intermediate frequency signal IFSIG is turned on for mixer circuitry 50 (e.g., a range of different frequencies F3 of FIG. 4). If desired, the optimal capacitances CA identified for the range of frequencies fLO may be stored or recorded in storage for use during subsequent signal transmission.

At operation 168, feedback path 104 may be turned off and a transmit signal may begin to be supplied to mixer circuitry 50 (e.g., the intermediate frequency signal IFSIG supplied to mixer circuitry 50 may be turned on). Mixer circuitry 50 may begin generating radio-frequency signal RFSIG by mixing local oscillator signal LO with intermediate frequency signal IFSIG and may begin transmitting radio-frequency signal RFSIG over the transmit path. At operation 170, gain control circuitry 94 or other control circuitry may set the capacitance Cc of tunable harmonic rejection circuitry 100 (e.g., using control signal CTRL) to the recorded optimal capacitance CA for the current frequency fLO of local oscillator signal LO (e.g., as identified at operation 166). Gain control circuitry 94 or the other control circuitry may adjust or change the capacitance Cc of tunable harmonic rejection circuitry 100 to different corresponding optimal capacitances CA as frequency fLO changes over time, such as when the frequency of radio-frequency signal RFSIG changes over time (e.g., as shown by curve 154 of FIG. 10).

In this way, feedback path 104 may identify and apply the optimal capacitances CA at tunable harmonic rejection circuitry 100 that configure transformer 60 to mitigate, trim out, cancel, reject, and/or suppress 2LO emissions produced by mixer circuitry 50 in the field in real time (e.g., after assembly and manufacture of wireless circuitry 24) without the use of an external spectrum analyzer. If desired, the operations of FIG. 11 may be repeated over time (e.g., as temperature or other conditions change) to ensure that the optimal capacitances CA for tunable rejection cancellation circuitry 100 continue to suppress 2LO emission by mixer circuitry 50 over time, regardless of environmental conditions. Identifying optimal capacitances CA prior to radio-frequency signal transmission may prevent the time required to identify optimal capacitances CA (e.g., while processing operations 160-166) from delaying or otherwise affecting radio-frequency signal transmission.

The methods and operations described above in connection with FIGS. 1-11 may be performed by the components of device 10 using software, firmware, and/or hardware (e.g., dedicated circuitry or hardware). Software code for performing these operations may be stored on non-transitory computer readable storage media (e.g., tangible computer readable storage media) stored on one or more of the components of device 10 (e.g., storage circuitry 16 and/or wireless circuitry 24 of FIG. 1). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10 (e.g., processing circuitry in wireless circuitry 24, processing circuitry 18 or control circuitry 14 of FIG. 1, etc.). The processing circuitry may include microprocessors, application processors, digital signal processors, central processing units (CPUs), application-specific integrated circuits with processing circuitry, or other processing circuitry.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is illustrative and various modifications can be made to the described embodiments. The foregoing embodiments may be implemented individually or in any combination.

What is claimed is:

1. A transmitter comprising:
mixer circuitry;
a transformer that includes a primary winding and a secondary winding, wherein the primary winding is coupled to an output of the mixer circuitry, and the secondary winding extends between a first terminal and a second terminal of the transformer;
a first signal line coupled to the first terminal;
a second signal line coupled to the second terminal;
an adjustable circuit coupled to a center tap of the secondary winding; and
signal strength indicator (SSI) measurement circuitry having an input communicatively coupled to the first signal line and the second signal line and having an output communicatively coupled to the adjustable circuit.

2. The transmitter of claim 1, wherein the adjustable circuit comprises an adjustable capacitor that couples the center tap of the secondary winding to a reference potential, the SSI measurement circuitry being communicatively coupled to a control input of the adjustable capacitor.

3. The transmitter of claim 2, further comprising:
an amplifier having an input coupled to the output of the SSI measurement circuitry and having an output communicatively coupled to the control input of the adjustable capacitor.

4. The transmitter of claim 3, wherein the adjustable capacitor comprises an adjustable varactor and the amplifier is configured to supply an analog control signal to the control input of the adjustable capacitor that adjusts a capacitance of the adjustable varactor.

5. The transmitter of claim 3, wherein the output of the SSI circuitry comprises a positive output terminal and a negative output terminal, the input of the amplifier comprises a positive input terminal and a negative input terminal, the positive output terminal of the SSI measurement circuitry is coupled to the negative input terminal of the amplifier, and the negative output terminal of the SSI measurement circuitry is coupled to the positive input terminal of the amplifier.

6. The transmitter of claim 2, further comprising:
an analog-to-digital converter (ADC) having an input coupled to the output of the SSI measurement circuitry and having an output communicatively coupled to the control input of the adjustable capacitor.

7. The transmitter of claim 6, further comprising:
digital circuitry that couples an output of the ADC to the control input of the adjustable capacitor, wherein the adjustable capacitor comprises a bank of switchable capacitors, and the digital circuitry is configured to supply a digital control signal to switches in the bank of switchable capacitors.

8. The transmitter of claim 1, further comprising:
voltage offset circuitry that couples the input of the SSI measurement circuitry to the first signal line and the second signal line.

9. The transmitter of claim 1, wherein the mixer circuitry includes a first mixer coupled to a third terminal of the transformer and includes a second mixer coupled to a fourth terminal of the transformer, the primary winding extends between the third terminal and the fourth terminal, and the transmitter further comprises:
a power amplifier having a positive input terminal coupled to the first signal line and having a negative input terminal coupled to the second signal line.

10. Wireless circuitry comprising:
mixer circuitry;
a transformer that includes a primary winding and a secondary winding, the primary winding being coupled to an output of the mixer circuitry;
a transmission line path coupled to the secondary winding;
an adjustable capacitor that couples a center tap of the secondary winding to a reference potential; and
a sensor communicatively coupled to the transmission line path, wherein
the sensor is configured to measure a signal strength indicator (SSI) value of a signal on the transmission line path, and
the adjustable capacitor has a capacitance that is set based on the SSI value.

11. The wireless circuitry of claim 10, further comprising:
gain control circuitry that couples an output of the SSI sensor to a control input of the adjustable capacitor, the gain control circuitry being configured to set the capacitance of the adjustable capacitor based on the SSI value.

12. The wireless circuitry of claim 11, the gain control circuitry comprising:
an amplifier having a positive input terminal coupled to a negative output terminal of the SSI sensor and having a negative input terminal coupled to a positive output terminal of the SSI sensor, wherein the adjustable capacitor comprises a varactor and the amplifier is configured to output, based on the SSI value, an analog control signal that configures the varactor to exhibit the capacitance.

13. The wireless circuitry of claim 11, the gain control circuitry comprising:
an analog-to-digital converter (ADC) having a positive input terminal coupled to a negative output terminal of the SSI sensor and having a negative input terminal coupled to a positive output terminal of the SSI sensor, wherein the adjustable capacitor comprises a bank of switchable capacitors; and
digital circuitry coupled between an output of the ADC and switches in the bank of switchable capacitors, wherein the digital circuitry and the ADC are configured to output, based on the SSI value, a digital control signal that configures the bank of switchable capacitors to exhibit the capacitance.

14. The wireless circuitry of claim 10, wherein the sensor is configured to measure the SSI value while the mixer circuitry receives a local oscillator signal but not a transmit signal.

15. The wireless circuitry of claim 14, wherein the capacitance configures the transformer to suppress a second order harmonic emission associated with the local oscillator signal.

16. The wireless circuitry of claim 10, further comprising:
offset circuitry coupled between the sensor and the transmission line path, wherein the offset circuitry is configured to add an offset voltage to the signal that cancels out a direct current (DC) offset of the sensor.

17. A method of operating a transmitter comprising:
generating, using a mixer during a first time period, a first signal based on a local oscillator signal;
passing, using a transformer during the first time period, the first signal onto a transmission line, wherein the transformer includes a primary winding coupled to the mixer and includes a secondary winding coupled to the transmission line;
measuring, using a sensor during the first time period, a signal strength indicator (SSI) value of the signal on the transmission line;
identifying, using a feedback path coupled between the transmission line and an adjustable capacitor, a capacitance for the adjustable capacitor that minimizes the SSI value, wherein the adjustable capacitor is coupled to a center tap of the secondary winding;
generating, using the mixer during a second time period, a second signal based on the local oscillator signal and a transmit signal; and
passing, using the transformer during the second time period, the second signal onto the transmission line while the adjustable capacitor exhibits the capacitance.

18. The method of claim 17, wherein the mixer does not receive the transmit signal during the first time period and the mixer receives the transmit signal during the second time period.

19. The method of claim 17, wherein the sensor is in the feedback path and identifying the capacitance for the adjustable capacitor comprises:
generating, using gain control circuitry coupled between the sensor and the adjustable capacitor, a control signal based on the SSI value; and
adjusting, using the gain control circuitry, the adjustable capacitor based on the control signal.

20. The method of claim 17, wherein identifying the capacitance for the adjustable capacitor comprises:
identifying the capacitance for the adjustable capacitor while the feedback path is closed; and
identifying, using the sensor and offset circuitry, a DC offset of the sensor prior to closing the feedback path, wherein the offset circuitry applies, to the signal after the feedback path is closed, an offset voltage that cancels out the identified DC offset of the sensor.
